(19) United States
(12) Patent Application Publication
(10) Pub. No.: US 2022/0188662 A1
(43) Pub. Date: Jun. 16, 2022

(54) CRITICALITY DETECTION FOR AUTOMATION RISK MITIGATION

(71) Applicant: KYNDRYL, INC., New York, NY (US)

(72) Inventors: Sasikala Palanisamy, Chennai (IN); Thiyagarajan Ramasubbu, Bangalore (IN); Alwyn R. Lobo, Bangalore (IN)

(21) Appl. No.: 17/118,076

(22) Filed: Dec. 10, 2020

(51) Int. Cl. G06N 5/04; G06N 20/00; G06Q 10/10; G06Q 10/06

(52) U.S. Cl. CPC G06N 5/04; G06Q 10/0631; G06Q 10/10; G06N 20/00

(57) ABSTRACT

A planned action is evaluated to determine a risk of failure. Context information of a target application of the planned action is also evaluated to determine a context risk. Based on the context risk and the failure risk, an overall risk level is determined for the planned action. This overall risk level is compared to a threshold; if the risk level is higher than the threshold, a user may be prompted to approve the planned action.

### BACKGROUND

The systems and methods of the present disclosure relate to automation.

Automation is becoming increasingly commonplace in many industries. Most automation implementations follow a relatively simple 3-stage flow, “detect-decide-execute.” Such systems detect an input (such as from a user or an application) triggering an automated process, decide upon an action to take (such as selecting one or more commands for execution and a target application), and execute the action (by executing the command(s) decided upon at the previous stage).

### SUMMARY

Some embodiments of the present disclosure can be illustrated as a method. The method comprises receiving a planned action. The method further comprises calculating a failure risk of the planned action. The method further comprises receiving context information of an application. The method further comprises calculating a context risk of the application. The method further comprises determining a risk level of the planned action. The method further comprises comparing the risk level to a threshold. The method further comprises prompting a user for approval of execution of the planned action.

Some embodiments of the present disclosure can also be illustrated as a computer program product comprising a computer readable storage medium having program instructions embodied therewith, the program instructions executable by a computer to cause the computer to perform the method discussed above.

Some embodiments of the present disclosure can be illustrated as a system. The system may comprise memory and a central processing unit (CPU). The CPU may be configured to execute instructions to perform the method discussed above.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Features and advantages of various embodiments of the claimed subject matter will become apparent as the following Detailed Description proceeds, and upon reference to the drawings, in which like numerals indicate like parts, and in which:

FIG. 1 is a high-level method for controlling an automation workflow, consistent with several embodiments of the present disclosure.

FIG. 2 is a risk determination method for automated actions, consistent with several embodiments of the present disclosure.

FIG. 3 is a risk determination data flow diagram, consistent with several embodiments of the present disclosure.

FIG. 4 is a diagram of an example confirmation prompt, consistent with several embodiments of the present disclosure.

FIG. 5 is a method for controlling an automation workflow accounting for action urgency, consistent with several embodiments of the present disclosure.

FIG. 6 is a high-level block diagram of an example computer system that may be used in implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to systems and methods to mitigate risk of automated systems by detecting action criticality. More particular aspects relate to a system to receive an action that a system intends to execute, determine a risk level of the action, and, based on the risk level, either halt execution until a user approves the action, or allow execution.

While becoming increasingly commonplace, automation systems are still typically developed relatively slowly over time. Upon making a decision (such as at a “decide” step of a “detect-decide-execute” flow), typical automation engines will not have the decision vetted by a user prior to execution.

Further, decision engines may decide upon actions that are likely to cause a failure at execution. For example, a decision engine may attempt to cause an application to execute a command that the application is actually incapable of executing (e.g., the command may be formatted improperly, the application may not have permission to execute the command, the command may attempt to access an invalid address, etc.). The type of failure resulting may vary; for example, in some instances, the command simply won't be executed. In more severe instances, an application may crash. Review methods described herein may allow a reviewer to detect such actions. However, typical systems are generally unable to distinguish between which actions need to be reviewed and which do not. Thus, systems might frequently unnecessarily require review of many actions, or even all actions, which can result in significant resource consumption and delays. This is also addressed via the systems and methods described herein.

In addition, some applications may be particularly sensitive to change and/or failures. For example, an administrator may be less likely to permit questionable commands to be executed on a mission-critical application (such as a hospital network manager) when compared to a relatively unimportant application (such as one managing a website's news feed). Many factors can come into play in this determination; applications may be flagged with a “change freeze” (meaning no changes can be made to the application), applications in some industries may be less tolerant of certain failures (for example, a brief period of downtime in a stock market trading application may be significantly more harmful than the same period of downtime in a retail application), etc.

Systems and methods consistent with the present disclosure advantageously enable automatic calculation of risk of a planned action, accounting for both a risk of failure associated with the planned action and a context risk associated with an application targeted by the planned action. Further, systems and methods consistent with the present disclosure enable automatically determining whether user approval is necessary for the execution of a given planned action and if so, prompting the user for such approval.

Throughout this disclosure, reference is made to “commands” and “actions.” A “command” refers to a computer-executable operation, such as “restart.” An “action,” as used herein, refers to a higher-level description of a command or group of multiple commands. As an example, “allocate additional processing resources to application X” is an action which, in practice, may require the execution of multiple commands. For example, such an action may be performed via multiple commands that change various flags and/or registers that control the number of resources a particular application or set of applications are allocated. Such a command could be, for example, “set app_Y_allocation_flag to 0.5” or “set app_X_allocation_flag to 1.2.” A “planned action” refers to an action proposed for execution (by, for example, a decision engine of an automation system). In typical automation systems, a planned action would be promptly executed. However, systems and methods consistent with the present disclosure enable classifying a risk of the planned action and, based on the risk, determining whether to prompt a user to approve/deny execution of the action, or to proceed to execution (i.e., without prompting for approval).

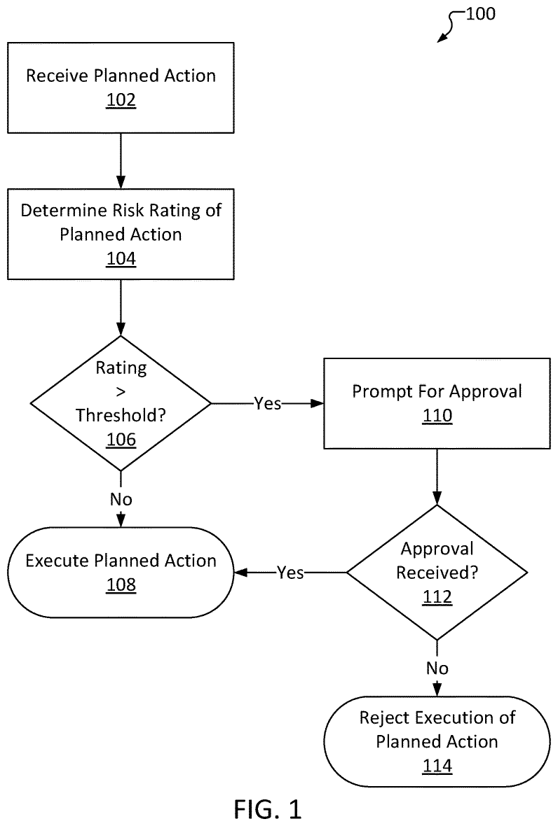

FIG. 1 is a high-level method 100 for controlling an automation workflow, consistent with several embodiments of the present disclosure. Method 100 comprises receiving information, including a planned action, at operation 102. Operation 102 may include, for example, receiving a command or list of commands from a decision engine of an automation system. Example planned actions include “restart,” “reallocate resources,” “start process,” “kill process,” “restart daemon,” “unlock ID,” “block IP,” “expand space,” “add volume,” etc. The planned action may be directed to be executed by a specific application (referred to herein as a “target application”). Operation 102 may also trigger an interrupt, preventing the execution of the planned action at least until method 100 has completed.

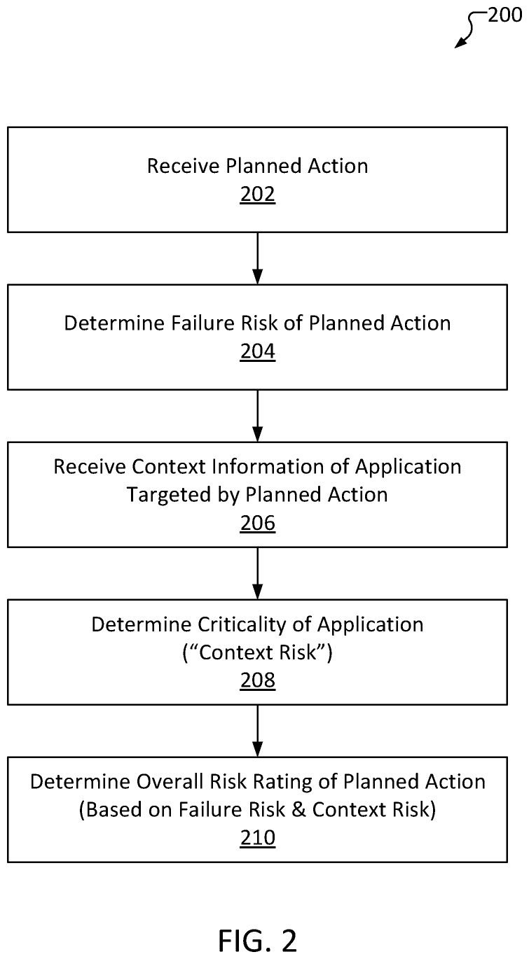

Method 100 further comprises determining a risk rating of the planned action at operation 104. Operation 104 may include, for example, determining a number representing a level of risk associated with the planned action (e.g., 0 for “harmless,” 3 for “critical”). The risk rating may be determined based upon a failure risk and a context risk. The “failure risk” and “context risk” are described in further detail below with reference to method 200 of FIG. 2, but as a general overview, “failure risk” describes a risk that the planned action will result in a failure of some sort (e.g., a failed execution, a system crash, etc.), while “context risk” describes a sensitivity of the target application to various types of failure (such as by accounting for an importance ranging from “unimportant” to “mission-critical,” determining if the application is particularly sensitive to certain types of failure, etc.).

Method 100 further comprises determining whether the risk is greater than a risk threshold at operation 106. The risk threshold may be set by, for example, a user or administrator of a system performing method 100. In essence, operation 106 is used to determine whether user approval is necessary for the execution of the planned action. One example risk threshold may be, for example, a number between 0 and 1, where 0 represents a minimum risk, and 1 represents a maximum risk. A risk threshold of 0 according to such a format may effectively cause all decisions to be submitted for approval, while a risk threshold of 1 may effectively cause all decisions to be executed. Other threshold formats include an index of a list of classifications (e.g., where “0” is “harmless,” “1” is “safe,” “2” is “risky,” and “3” is “critical,” a threshold of “1” may result in planned actions that are classified as “risky” or “critical” being submitted for approval.

A particularly high risk threshold may result in most actions decided upon by a decision engine to be executed without user approval. A high threshold may be desirable for a relatively well-established automation system (e.g., an automation system that has been functioning for an extended period of time), if users of the automation system are comfortable with minimal human input, etc. As an example, a system controlling a state of a hall light might be provided with a relatively high threshold so as to prevent bothering users unnecessarily with prompts requesting approval for changing the state of the light. On the other hand, a relatively low threshold, which may result in more frequent interruptions for approval, may be desirable for higher-security systems, newly-deployed systems, and the like. As an example, a system controlling temperature and/or pressure of an industrial autoclave may have a relatively low threshold, as even relatively minor erroneous adjustments may result in significant problems.

If the risk is below the threshold (106 “No”), method 100 further comprises executing the planned action at operation 108. In some embodiments, operation 108 may include resuming a previously-interrupted operation of an automation system. In some embodiments, operation 108 may include passing the planned action to an execution engine. Operation 108 may include, for example, allowing an execution engine of an automation system to execute the planned action. In some embodiments, an outcome of the execution may be monitored and recorded. For example, if the execution resulted in a failure, this may be detected and utilized to refine a machine learning model utilized to predict a failure risk.

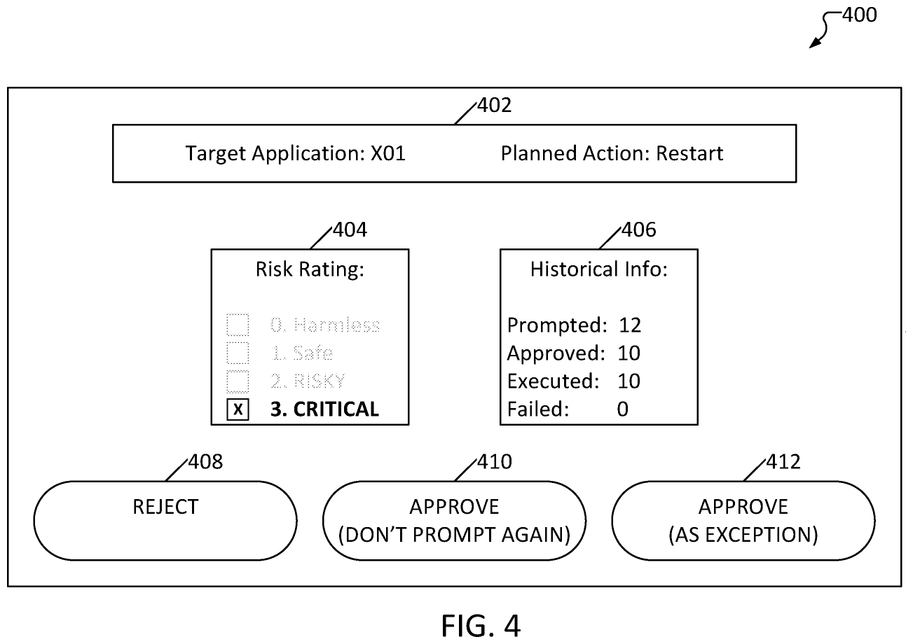

If the risk is above the threshold (106 “Yes”), method 100 further comprises prompting for approval at operation 110. Operation 110 may include, for example, causing a notification to be displayed (such as by transmitting a signal to a user's device, a control panel, etc.). An example of such a prompt is shown in FIG. 4, discussed in detail below. In general, the prompt may enable a user to decide whether to allow the planned action to be executed or to reject it.

Method 100 further comprises determining whether approval has been received at operation 112. Operation 112 may include, for example, detecting a user input in response to the prompt and determining whether the input corresponds to an approval or a rejection. In some embodiments, operation 112 may also include monitoring a time elapsed since the prompt was generated at operation 110 and, if the time elapsed is greater than a threshold, automatically rejecting execution of the planned action (a “prompt timeout”). In some embodiments not illustrated in FIG. 1, depending upon the planned action, a timeout may result in the execution of the planned action (for example, a risk rating of a planned action may be “borderline” such that approval might be preferable, but not worth delaying execution over).

If approval has been received (112 “Yes”), method 100 proceeds to executing the planned action via operation 108. If approval has not been received (112 “No”), either via receiving an affirmative denial or, in some embodiments, via a prompt timeout, method 100 comprises rejecting execution of the planned action at operation 114. Operation 114 may include, for example, transmitting a message to an execution engine to indicate that the planned action will not be executed. The message may include status information, describing, for example, whether the rejection is due to a user response or to a prompt timeout, which user (if any) rejected execution, etc.

FIG. 2 is a risk determination method 200 for automated actions, consistent with several embodiments of the present disclosure. Method 200 comprises receiving information including a planned action at operation 202. Operation 202 may be performed in a substantially similar manner to operation 102 of method 100 (discussed above with reference to FIG. 1).

Method 200 further comprises determining a failure risk of the planned action at operation 204. Operation 204 may include, for example, calculating a likelihood (such as an estimated percentage chance) that the planned action results in one or more failures (e.g., a crash, a failure to execute a command, data loss, etc.). The failure risk may be determined based on historical data, such as a historical failure rate of the planned action. For example, if a given planned action includes a command that, upon attempted execution, resulted in failure during every previous attempt, operation 204 may determine a significant failure risk. In addition, operation 204 may leverage machine learning techniques to detect trends between platforms, commands included in the planned action, and outcome (i.e., failure or not), enabling more accurate failure risk evaluation.

In some embodiments, the planned action information received at operation 202 may identify an application targeted by the planned action (the “target application”). The information received at operation 202 may also include hardware information, such as a platform on which the target application is executing. This information may be leveraged when determining the failure risk at operation 204; for example, a command may be more likely to result in failure on a first platform (such as a computer system running MICROSOFT WINDOWS) than on a second platform (such as a computer system running LINUX).

Method 200 further comprises receiving context information of the target application at operation 206. “Context information” refers to information regarding the target application such as settings, flags, uptime, etc. In some embodiments, hardware information received at operation 202 can also be utilized as “context information.” As an example, operation 206 may include receiving information identifying an industry of the target application (e.g., stock market, healthcare, retail, etc.). As an additional example, operation 206 may include determining that the target application is flagged as “mission-critical” (via checking a corresponding field). Other examples include checking for a “change freeze” or a similar “lock” flag on the system.

Method 200 further comprises determining criticality of the target application (also referred to herein as a “context risk”) at operation 208. The context risk determined via operation 208 may describe the target application's sensitivity to failure. Operation 208 may include, for example, evaluating the context information received at operation 206 in order to determine a level of criticality of the target application. As an example, a “mission-critical” flag detected at operation 206 may result in determining, at operation 208, that the target application is critically important (a relatively high context risk), although the lack of a mission-critical flag does not necessarily indicate that the target application is not critical.

In some embodiments, operation 208 may further account for properties of the planned action and/or failure risk. This may advantageously account for more specific relationships between the planned action and the target application. As an example, an industry of the target application (as gleaned from the context information received at operation 206) may be considered along with one or more types of failure (with a likelihood above a threshold) predicted at operation 204 in order to determine the context risk. Different industries may have different sensitivities to various failures, and these sensitivities may be stored in a table of a system consistent with the present disclosure. For example, if the industry of the target application is “banking” and a “command not executed” failure is the only likely failure to result from the planned action, the context risk may be higher than if the industry of the target application were “healthcare.” However, if a “crash” failure is the only likely failure to result from the planned action, then the context risk may be lower for the “banking” application than the “healthcare” application.

Method 200 further includes determining an overall risk rating of the planned action at operation 210. Operation 210 may include, for example, combining the failure risk and context risk into a single classification or rating. As a simple example, a failure risk may be a first value from 0 to 1, a context risk may be a second value from 0 to 1, and operation 210 may include multiplying the two risks. In some use cases, operation 210 may account for special exceptions; for example, a flag detected at operation 206 may result in a determination at operation 210 that the planned action is a “critical” risk regardless of the failure risk. This may enable application-side control of whether planned actions require approval or not. Similarly, a “never prompt” flag may result in executing planned actions regardless of determined risk, effectively disabling risk detection.

In some embodiments, operation 210 may further include accounting for specific relationships between the planned action, predicted failure(s), and the target application. As an example, an industry of the target application (as gleaned from the context information received at operation 206) may be considered along with one or more types of failure (with a likelihood above a threshold) predicted at operation 204 in order to determine the overall risk. Different industries may have different sensitivities to various failures, and these sensitivities may be stored in a table of a system consistent with the present disclosure. For example, if the industry of the target application is “banking” and a “command not executed” failure is the only likely failure to result from the planned action, the overall risk may be higher than if the industry of the target application were “healthcare.” However, if a “crash” failure is the only likely failure to result from the planned action, then the overall risk may be lower for the “banking” application than the “healthcare” application. Specific relationships can be identified in several other ways as well; for example, the context information received at operation 206 may include a table detailing impacts that various failure types may have on the target application. In other words, a target application may indicate, via context information, that a crash failure is considered particularly critical while a command not executed failure is considered less of a concern. This information may be utilized, in combination with the failure risk, to determine or refine the overall risk.

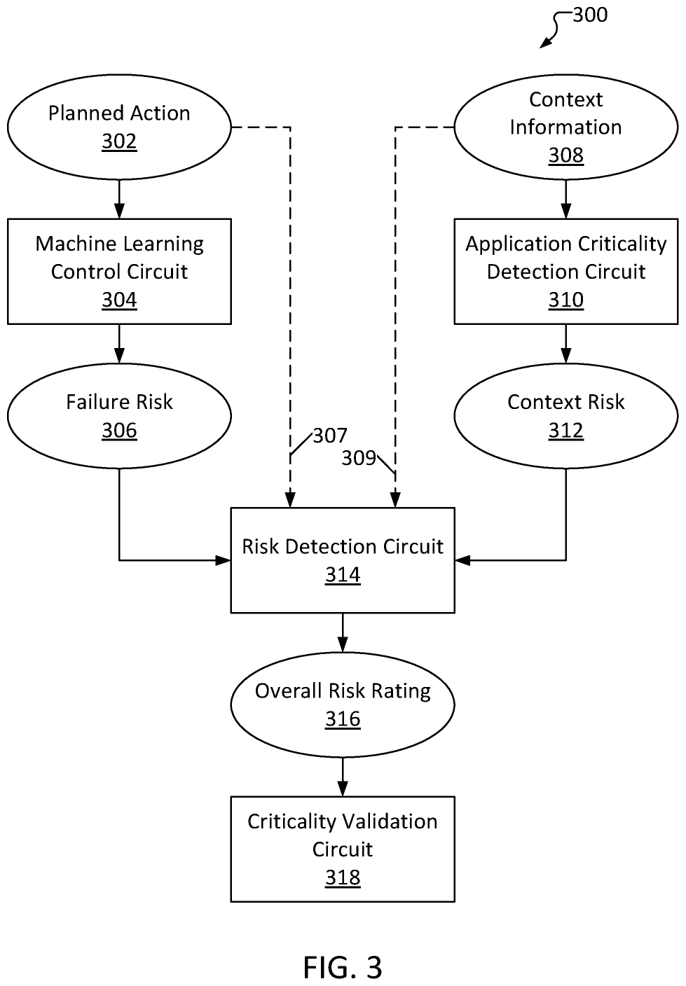

FIG. 3 is a risk determination data flow diagram 300, consistent with several embodiments of the present disclosure. Diagram 300 is presented as an example of how methods consistent with the present disclosure (such as method 200) may be implemented, with ellipses (such as planned action 302 and failure risk 306) representing information input to/output from circuits (such as machine learning control circuit 304 and risk detection circuit 314), and with rectangles representing those circuits. The circuits depicted in FIG. 3 may be implemented as electronic circuitry including, for example, programmable logic circuitry, field-programmable gate arrays (FPGA), or programmable logic arrays (PLA) application-specific integrated circuits (ASIC), system on a chip (SoC), microprocessor, or a system with a CPU, RAM, etc.

A planned action 302 is received (from, for example, an automation system's decision engine) as input at a machine learning control circuit 304. Machine learning control circuit 304 is configured to determine, based on the planned action, a failure risk 306 associated with the planned action. Failure risk 306 may be determined, for example, according to operation 204 of method 200, discussed above with reference to FIG. 2. In some embodiments, planned action information 302 may identify a target application (which may include a platform on which the target application is executing, such as an operating system, etc.). Machine learning control circuit 304 may leverage a machine learning model in order to predict whether the planned action is likely to result in a failure.

Context information 308 may be received (for example, from a target application or a system executing the target application) as input to an application criticality detection circuit 310. Application criticality detection circuit 310 may determine and output a context risk 312 based on context information 308. Context risk 312 may be determined, for example, according to operation 208 of method 200, discussed above with reference to FIG. 2.

Failure risk 306 and context risk 312 may both be input to risk detection circuit 314. Risk detection circuit 314 may utilize risks 306, 312 in order to determine and output an overall risk rating 316. For example, risk detection circuit 314 may multiply, sum, or average risks 306 and 312. Overall risk rating 316 may represent an overall risk of the planned action, weighted based on the context of the target application. In some embodiments, risk detection circuit 314 may also receive planned action 302 and/or context information 308 (as indicated by dashed lines 307 and 309, respectively), in order to determine overall risk rating 316. This may advantageously enable overall risk rating 316 to better represent the context of the target application (e.g., industry, sensitivities to specific failure types, etc.). Overall risk rating 316 may then be submitted to criticality validation circuit 318, which compares overall risk rating 316 to a threshold in order to determine how to proceed (such as whether to allow execution or require approval via a prompt).

FIG. 4 is a diagram of an example confirmation prompt 400, consistent with several embodiments of the present disclosure. Prompt 400 may be presented to a user in response to determining that a risk of a planned action to a target application exceeds a threshold. Prompt 400 includes overview 402, listing a target application and a planned action. Prompt 400 further includes a risk rating 404, displaying an identified level of risk of the planned action. In the example depicted in FIG. 4, the planned action has been identified as having “critical” risk. For example, a system that caused prompt 400 to be depicted may have determined, in response to receiving the planned action (“restart”), that the target application X01 is both mission-critical and under a change freeze. These determinations may have led the system to determine that a restart (the planned action) is unacceptable. In some embodiments, prompt 400 may include this explanation (though it is not depicted in FIG. 4). Example prompt 400 also includes historical information 406. Historical information 406 may include, for example, counts of times the same planned action has been prompted, approved, executed, and determined to have resulted in failure. Example prompt 400 also includes buttons to enable a user to control whether the planned action is executed or rejected. For example, example prompt 400 includes REJECT button 408, which results in the prevention of execution of the planned action.

Example prompt 400 further includes APPROVE (DON'T PROMPT AGAIN) button 410, which may result in approving the planned action for execution and modifying a flag or register to circumvent future prompts for the same planned action and target application combination. Such a flag may be checked in the future via, for example, operation 206 of method 200, and may result in permitting execution of the planned action regardless of a calculated failure risk or application criticality.

Example prompt 400 further includes APPROVE (AS EXCEPTION) button 412, which may result in approved the planned action for execution without adjustment. For example, button 412 may result in execution without changing any flags in the application, such that future instances of the same planned action and target application may similarly result in a prompt.

In some embodiments, a prompt may omit some of the information or options depicted in FIG. 4. Further, a prompt may include information such as a time elapsed since the prompt was sent, a time remaining before a timeout condition occurs, etc.

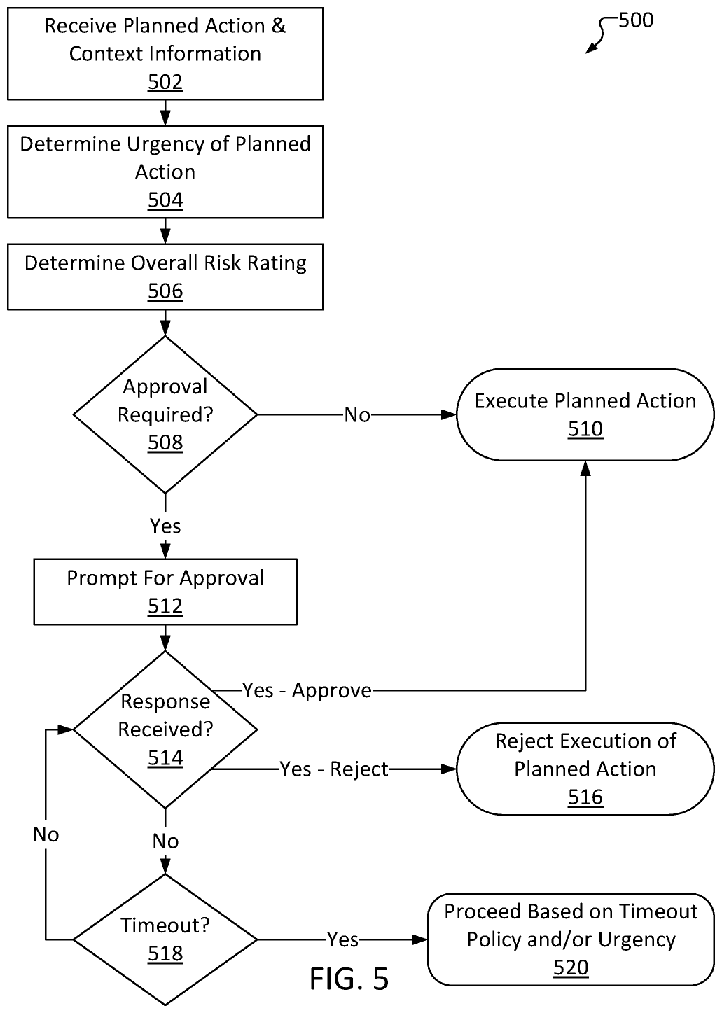

FIG. 5 is a method 500 for controlling an automation workflow accounting for action urgency and a timeout policy, consistent with several embodiments of the present disclosure. In essence, method 500 may be performed by certain configurations that allow specific planned actions to be executed without approval, even if similarly-risky actions might require approval. This may be advantageous in some contexts, for example, if the planned action is safety-related.

Method 500 comprises receiving planned action and context information at operation 502. Operation 502 may be performed in a substantially similar manner to, for example, operations 202 and 206 of method 200.

Method 500 further comprises determining an urgency of the planned action at operation 504. Operation 504 may include, for example, determining whether either of the planned action or the target application are marked as safety-related (such as by determining whether they include markers that indicate that they are safety-related). As an example, a determination that the planned action would activate an emergency response (such as a fire suppression system, emergency shutoff, etc.) may be considered particularly urgent. Urgency may be determined based on the planned action and/or the context information received at operation 502.

Method 500 further comprises determining an overall risk rating at operation 506. Operation 506 may be performed in a substantially similar manner to, for example, operation 210 of method 200, as described above with reference to FIG. 2. For example, operation 506 may include comparing a failure risk and a context risk.

Method 500 further comprises determining whether approval is required at operation 508. Operation 508 may include comparing the risk determined at operation 506 to a risk threshold in a manner similar to operation 106 of method 100. The risk threshold used at operation 508 may depend upon the embodiment and the urgency determined at operation 504. In simple terms, more urgent planned actions may be less likely to require approval. For example, the risk threshold may be modified based on an urgency, resulting in a modified risk threshold. As a clarifying example, a baseline threshold risk rating of 0.6 might be a minimum risk level above which approval is required in some embodiments, so the execution of a planned action having a risk rating of 0.65 might ordinarily be suspended until approval can be received from a user. However, in some embodiments, the threshold may be divided by an urgency rating of 0.5, resulting in a modified threshold of 1.2, so the planned action may no longer require approval. The preceding example is presented for purposes of illustration only; other ways of accounting for the urgency are also considered. For example, in some instances, a determination that the planned action is safety-related may result in an increased threshold in addition to (or instead of) an increased determined urgency. In some embodiments, a separate “urgency threshold” comparison may be performed, wherein if an action is urgent enough, it may be executed regardless of risk.

If approval is not required (508 “No”), method 500 further comprises executing the planned action at operation 510. Operation 510 may be performed in a substantially similar manner as operation 108 of method 100, as described above with reference to FIG. 1. Similarly, if approval is required (508 “Yes”), method 500 further comprises prompting for approval at operation 512. Operation 512 may be performed in a substantially similar manner to operation 110 of method 100. In some embodiments, operation 512 may include urgency information in a prompt.

Method 500 further comprises determining whether a response to the prompt has been received at operation 514. If a response has been received, method 500 further comprises proceeding according to the response. For example, if the response approved execution (514 “Yes—Approve”), method 500 proceeds to executing the planned action at operation 510. If the response rejected execution (514 “Yes—Reject”) method 500 comprises rejecting execution of the planned action at operation 516.

If no response has been received (514 “No”), method 500 further comprises determining if a timeout condition has been met at operation 518. Operation 518 may include, for example, comparing a time elapsed since the prompt was submitted at operation 512 and comparing it to an elapsed time threshold. If the elapsed time is less than the threshold, a timeout has not occurred (518 “No”), and method 500 returns to operation 514 (in essence, waiting for a response).

If the elapsed time is equal to or greater than the threshold, a timeout has occurred (518 “Yes”), and method 500 further comprises proceeding based on a timeout policy and the determined urgency at operation 520. Operation 520 may include, for example, comparing the determined urgency to a table of appropriate responses; non-urgent planned actions may be rejected upon timeout, while maximum-urgency planned actions may be executed. Additional conditions may also be considered (finance-related urgent actions may be rejected while safety-related urgent actions may be executed).

The timeout threshold may be determined by the timeout policy or be set by a user or administrator of a system performing method 500. The timeout policy can further support multiple different timeout thresholds depending upon the circumstance. For example, a user may set a relatively short timeout threshold (e.g., 15 seconds) to be utilized when considering safety-related planned actions, but a relatively long timeout threshold (e.g., 120 seconds) to be utilized when considering finance-related planned actions. The timeout threshold may further be impacted by the determined urgency. For example, more urgent planned actions may have shorter timeout thresholds if the timeout policy dictates that they be executed upon timeout. More urgent planned actions may have longer timeout thresholds if the timeout policy dictates that the planned action is denied upon timeout.

In some embodiments, if a planned action has been approved a certain percentage of times (up to and possibly including 100%), the planned action may eventually be flagged to no longer be prompted. For example, a planned action may be a “Restart” command targeting a banking application. The action may be considered risky enough to require approval, resulting in a prompt being sent to a user. The user may approve the action, resulting in the application being restarted. However, the user may have been prompted about a restart for the same application repeatedly in the past. If the user had approved the restart for the same application 50 times in a row, a flag may be set such that, in the future, the same action will be executed without needing approval. This may advantageously improve efficiency in some embodiments, but may not be preferable in some situations (such as where control over the automation system is particularly important). In some embodiments, rather than skipping approval entirely, a timeout policy may be modified such that the planned action is executed in the event of a timeout rather than rejected. In some embodiments, a user may be notified when this modification occurs (and presented with an option to deny or revert it). In some embodiments, a user may be notified when the planned action is executed without approval.

Similarly, in some embodiments, if a planned action is repeatedly executed without needing approval but the execution results in failure, the action may be flagged as having a particularly high failure risk (even if the detected failure risk may be relatively low). In some embodiments, such an action may be flagged as requiring approval regardless of risk.

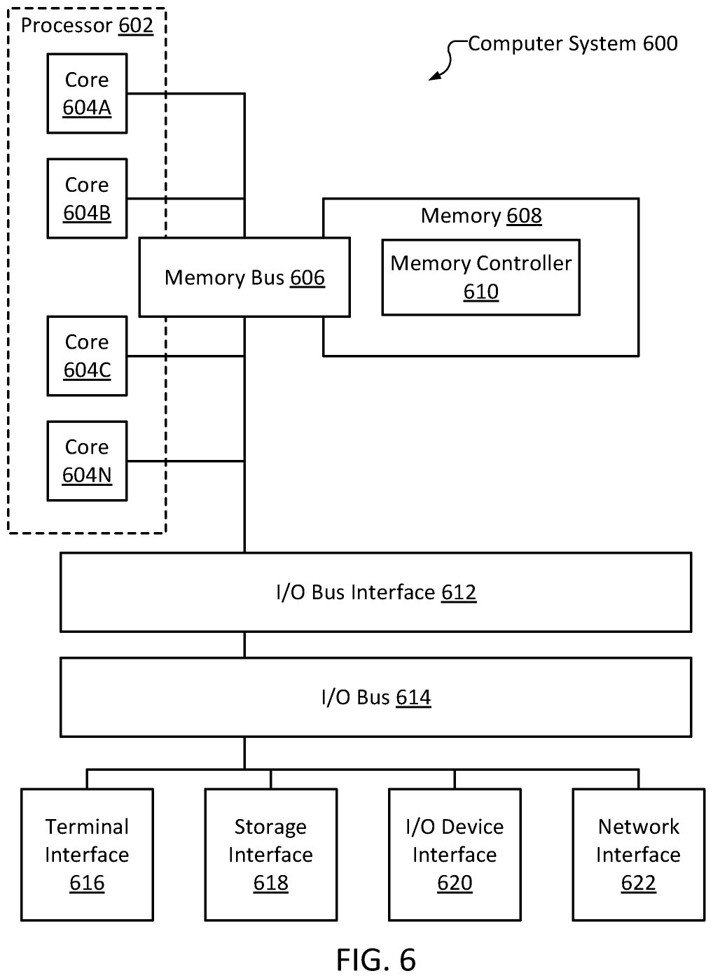

Referring now to FIG. 6, shown is a high-level block diagram of an example computer system 600 that may be configured to perform various aspects of the present disclosure, including, for example, methods 100, 200, and 500. The example computer system 600 may be used in implementing one or more of the methods or modules, and any related functions or operations, described herein (e.g., using one or more processor circuits or computer processors of the computer), in accordance with embodiments of the present disclosure. In some embodiments, the major components of the computer system 600 may comprise one or more processors 602 (such as, for example, one or more central processing units (CPUs)), a memory subsystem 608, a terminal interface 616, a storage interface 618, an I/O (Input/Output) device interface 620, and a network interface 622, all of which may be communicatively coupled, directly or indirectly, for inter-component communication via a memory bus 606, an I/O bus 614, and an I/O bus interface unit 612.

The computer system 600 may contain one or more general-purpose programmable central processing units (CPUs) 602, some or all of which may include one or more cores 604A, 604B, 604C, and 604D, herein generically referred to as the CPU 602. In some embodiments, the computer system 600 may contain multiple processors typical of a relatively large system; however, in other embodiments the computer system 600 may alternatively be a single CPU system. Each CPU 602 may execute instructions stored in the memory subsystem 608 on a CPU core 604 and may comprise one or more levels of on-board cache.

In some embodiments, the memory subsystem 608 may comprise a random-access semiconductor memory, storage device, or storage medium (either volatile or non-volatile) for storing data and programs. In some embodiments, the memory subsystem 608 may represent the entire virtual memory of the computer system 600 and may also include the virtual memory of other computer systems coupled to the computer system 600 or connected via a network. The memory subsystem 608 may be conceptually a single monolithic entity, but, in some embodiments, the memory subsystem 608 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 608 may contain elements for control and flow of memory used by the CPU 602. This may include a memory controller 610.

Although the memory bus 606 is shown in FIG. 6 as a single bus structure providing a direct communication path among the CPU 602, the memory subsystem 608, and the I/O bus interface 612, the memory bus 606 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 612 and the I/O bus 614 are shown as single respective units, the computer system 600 may, in some embodiments, contain multiple I/O bus interface units 612, multiple I/O buses 614, or both. Further, while multiple I/O interface units are shown, which separate the I/O bus 614 from various communications paths running to the various I/O devices, in other embodiments some or all of the I/O devices may be connected directly to one or more system I/O buses.

In some embodiments, the computer system 600 may be a multi-user mainframe computer system, a single-user system, or a server computer or similar device that has little or no direct user interface but receives requests from other computer systems (clients). Further, in some embodiments, the computer system 600 may be implemented as a desktop computer, portable computer, laptop or notebook computer, tablet computer, pocket computer, telephone, smart phone, mobile device, or any other appropriate type of electronic device.

It is noted that FIG. 6 is intended to depict the representative major components of an exemplary computer system 600. In some embodiments, however, individual components may have greater or lesser complexity than as represented in FIG. 6, components other than or in addition to those shown in FIG. 6 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method, comprising:
receiving a first planned action;
calculating, based on the first planned action, a first failure risk of the first planned action;
receiving first context information of a first target application;
calculating, based on the first context information, a first context risk of the first target application;
determining, based on the first failure risk and on the first context risk, a first risk level of the first planned action;
comparing the first risk level to a risk threshold; and
sending, based on the comparison, a prompt to a user for approval of execution of the first planned action.

2. The method of claim 1, further comprising:
receiving an approval in response to the prompt; and
executing, based on the approval, the planned action.

3. The method of claim 1, further comprising:
receiving a denial in response to the prompt; and
preventing, based on the denial, execution of the planned action.

4. The method of claim 1, further comprising:
detecting, prior to receiving a response to the prompt, that an elapsed time is greater than a timeout threshold; and
preventing, based on the detecting, execution of the planned action.

5. The method of claim 1, further comprising:
receiving a second planned action;
calculating, based on the second planned action, a second failure risk of the second planned action;
receiving second context information of a second target application;
calculating, based on the second context information, a second context risk of the second target application;
determining, based on the second failure risk and on the second context risk, a second risk level of the second planned action;
comparing the second risk level to the risk threshold; and
executing, based on the comparing, the second planned action.

6. The method of claim 1, further comprising:
receiving a second planned action;
calculating, based on the second planned action, a second failure risk of the second planned action;
receiving second context information of a second target application;
calculating, based on the second context information, a second context risk of the second target application;
determining, based on the second failure risk and on the second context risk, a second risk level of the second planned action;
determining an urgency of the second planned action;
determining, based on the urgency, a modified risk threshold;
comparing the second risk level to the modified risk threshold; and
executing, based on the comparing, the second planned action.

7. The method of claim 1, wherein the calculating the context risk includes determining that the target application is flagged with a change freeze.

8. The method of claim 1, wherein the context information includes an industry of the target application.

9. The method of claim 1, wherein the executing is performed by the target application.

10. A system comprising:
a memory; and
a central processing unit (CPU) coupled to the memory, the CPU configured to:
receive a first planned action;
calculate, based on the first planned action, a first failure risk of the first planned action;
receive first context information of a first target application;
calculate, based on the first context information, a first context risk of the first target application;
determine, based on the first failure risk and on the first context risk, a first risk level of the first planned action;
compare the first risk level to a risk threshold; and
send, based on the comparison, a prompt to user for approval of execution of the first planned action.

11. The system of claim 10, wherein the CPU is further configured to:
receive an approval in response to the prompt; and
execute, based on the approval, the planned action.

12. The system of claim 10, wherein the CPU is further configured to:
receive a denial in response to the prompt; and
prevent, based on the denial, execution of the planned action.

13. The system of claim 10, wherein the CPU is further configured to:
detect a timeout without receiving a response to the prompt; and
prevent, based on the detecting, execution of the planned action.

14. The system of claim 10, wherein the CPU is further configured to:
receive a second planned action;
calculate, based on the second planned action, a second failure risk of the second planned action;
receive second context information of a second target application;
calculate, based on the second context information, a second context risk of the second target application;
determine, based on the second failure risk and on the second context risk, a second risk level of the second planned action;
compare the second risk level to the risk threshold; and
execute, based on the comparing, the second planned action.

15. The system of claim 10, wherein the CPU is further configured to:
receive a second planned action;
calculate, based on the second planned action, a second failure risk of the second planned action;
receive second context information of a second target application;
calculate, based on the second context information, a second context risk of the second target application;
determine, based on the second failure risk and on the second context risk, a second risk level of the second planned action;
determine an urgency of the second planned action;
determine, based on the urgency, a modified risk threshold;
compare the second risk level to the modified risk threshold; and
execute, based on the comparing, the second planned action.

16. A computer program product, the computer program product comprising a computer readable storage medium having program instructions embodied therewith, the program instructions executable by a computer to cause the computer to:
receive a first planned action;
calculate, based on the first planned action, a first failure risk of the first planned action;
receive first context information of a first target application;
calculate, based on the first context information, a first context risk of the first target application;
determine, based on the first failure risk and on the first context risk, a first risk level of the first planned action;
compare the first risk level to a risk threshold; and
send, based on the comparison, a prompt to a user for approval of execution of the first planned action.

17. The computer program product of claim 16, wherein the instructions further cause the computer to:
receive an approval in response to the prompt; and
execute, based on the approval, the planned action.

18. The computer program product of claim 16, wherein the instructions further cause the computer to:
detect a timeout without receiving a response to the prompt; and
prevent, based on the detecting, execution of the planned action.

19. The computer program product of claim 16, wherein the instructions further cause the computer to:
receive a second planned action;
calculate, based on the second planned action, a second failure risk of the second planned action;
receive second context information of a second target application;
calculate, based on the second context information, a second context risk of the second target application;
determine, based on the second failure risk and on the second context risk, a second risk level of the second planned action;
compare the second risk level to the risk threshold; and
execute, based on the comparing, the second planned action.

20. The computer program product of claim 16, wherein the instructions further cause the computer to:
receive a second planned action;
calculate, based on the second planned action, a second failure risk of the second planned action;
receive second context information of a second target application;
calculate, based on the second context information, a second context risk of the second target application;
determine, based on the second failure risk and on the second context risk, a second risk level of the second planned action;
determine an urgency of the second planned action;
determine, based on the urgency, a modified risk threshold;
compare the second risk level to the modified risk threshold; and
execute, based on the comparing, the second planned action.
